(19) United States
(12) Patent Application Publication
(10) Pub. No.: US 2021/0096892 A1
(43) Pub. Date: Apr. 1, 2021

(54) SNAPSHOT FOR COMPILER OPTIMIZATION

(71) Applicant: Red Hat, Inc., Raleigh, NC (US)

(72) Inventors: Francesco Nigro, Milan (IT); Daniele Zonca, Milan (IT)

(21) Appl. No.: 16/589,945

(22) Filed: Oct. 1, 2019

(51) Int. Cl. G06F 9/455; G06F 8/41

(52) U.S. Cl. CPC G06F 9/45525; G06F 8/41

(57) ABSTRACT

A method performed by a computing system includes, with a compiler, compiling source code to create an application for execution. The method further includes, after the compiling has started, recording a snapshot of compilation configurations, the compilation configurations including information obtained by the compiler during the compiling. The method further includes storing the snapshot in a predefined format and after storing the snapshot, loading the snapshot by configuring the compiler based on the compilation configuration in the snapshot.

### BACKGROUND

The present disclosure relates generally to methods and systems for compiling applications, and more particularly, improving the compilation process by taking snapshots of compiler configurations.

Compiling is the process by which human-readable source code is transformed into machine-readable code for execution on a processor. Some computer programming languages, such as Java, compile human-readable source code into a code meant for execution on a virtual machine, particularly, the Java Virtual Machine (JVM). This virtual machine executable code is referred to as bytecode. Some compilation processes, however, convert human readable source code directly into machine code for execution directly on physical hardware.

Various types of compilation are available, including Just-In-Time (JIT) compilation and Ahead-Of-Time (AOT) compilation. JIT compilation involves compiling computer code during execution of a program rather than before execution. In some examples, a JIT compiler regularly analyzes the code being executed to determine if further compilation or recompilation is warranted. If the improvement gained from recompilation outweighs the overhead of doing so, then code may be recompiled. AOT compilation, on the other hand, involves compiling source code before execution. With either type of compilation, the compilation process can take longer for larger and more complex applications. This is because the compiler has to configure itself and perform various steps to prepare for compilation of the specific application it is compiling. It is desirable to improve this process and decrease the compilation time.

### SUMMARY

According to one example, a method performed by a computing system includes, with a compiler, compiling source code to create an application for execution. The method further includes, after the compiling has started, recording a snapshot of compilation configurations, the compilation configurations including information obtained by the compiler during the compiling. The method further includes storing the snapshot in a predefined format. The method further includes, after storing the snapshot, loading the snapshot by configuring the compiler based on the compilation configuration in the snapshot.

According to one example, a system includes a processor and a memory. The memory includes machine-readable instructions that when executed by the processor cause the system to record a snapshot of accumulated compiler optimizations after compilation of an application by a compiler has started. The system is further to, during a subsequent compilation of the application, load the snapshot by configuring the compiler with the accumulated compiler optimizations. The system is further to continue compiling the application with the accumulated compiler optimizations.

A computer program product comprising non-transitory machine-readable media having machine-readable instructions for execution on a processor includes code for, with a compiler, compiling source code to create an application for execution. The computer program product further includes code for, after the compiling has started, recording a snapshot of compilation configurations, the compilation configurations including information obtained by the compiler during the compiling. The computer program product further includes code for storing the snapshot in a predefined format. The computer program product further includes code for, after storing the snapshot, loading the snapshot by configuring the compiler based on the compilation configuration in the snapshot.

### BRIEF DESCRIPTION OF THE DRAWINGS

FIG. 1 is a diagram showing an illustrative process flow for compiler optimization using snapshots, according to one example of principles described herein.

FIG. 2 is a flowchart showing an illustrative method for recording a snapshot, according to one example of principles described herein.

FIG. 3 is a flowchart showing an illustrative method for loading a snapshot, according to one example of principles described herein.

FIG. 4 is a flowchart showing an illustrative method for guiding ahead-of-time compilation, according to one example of principles described herein.

FIG. 5 is a diagram showing an illustrative computing system that may be used to perform the compilation processes described herein.

### DETAILED DESCRIPTION

In the following description, specific details are set forth describing some examples consistent with the present disclosure. It will be apparent, however, to one skilled in the art that some examples may be practiced without some or all of these specific details. The specific examples disclosed herein are meant to be illustrative but not limiting. One skilled in the art may realize other elements that, although not specifically described here, are within the scope and the spirit of this disclosure. In addition, to avoid unnecessary repetition, one or more features shown and described in association with one example may be incorporated into other examples unless specifically described otherwise or if the one or more features would make an example non-functional.

As explained above, it is desirable to improve the compilation process and decrease the compilation time. During compilation of a program, a compiler will take on various configurations to improve execution of the program it is compiling. The configurations may include compiler optimizations, counters, code cache, compiled classes and methods. These compiler configurations may take time to be realized. Thus, when compiling a compatible version of the program, it takes time for the compiler to warm up.

According to principles described herein, the time it takes to compile an application may be reduced by taking a snapshot of the compiler configurations. The compiler configurations in the snapshot may then be used for various purposes.

There are many advantages and benefits for using the snapshot principles described herein. For example, when performing JIT compilation, a containerized version of the application may be run using a specific snapshot. Additionally, a containerized version of the application may be hibernated. This may allow for native space to be reclaimed. When that hibernated application is woken up, it may load a compilation snapshot. Furthermore, when performing AOT compilations, a snapshot may be used to guide the compilation process, which may allow for specific applications paths instead of generic paths. By improving the compilation process using techniques described herein, applications are able to run more efficiently.

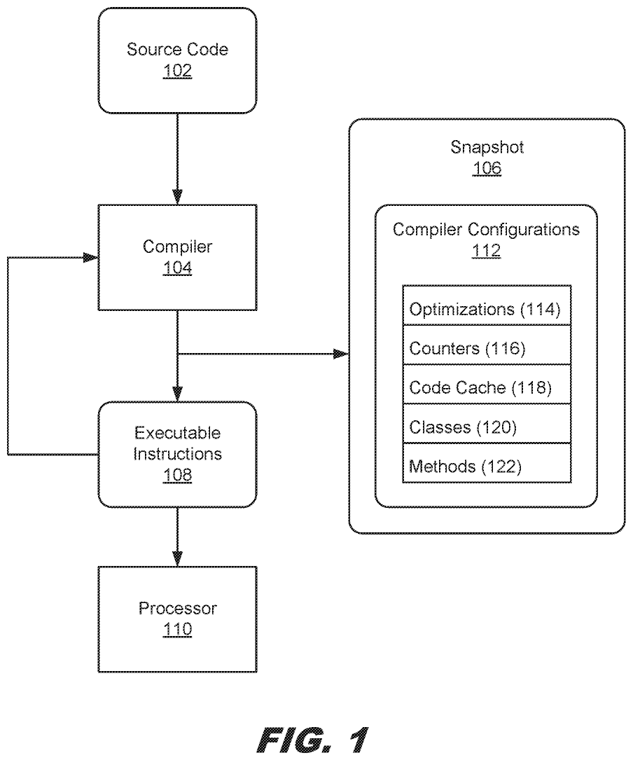

FIG. 1 is a diagram showing an illustrative process flow for compiler optimization using snapshots. According to the present example, source code 102 is compiled using a compiler 104 to produce executable instructions 108 for execution on a processor 110. During or after compiling the source code 102, a snapshot 106 of compiler configurations 112 is taken. The compiler configurations 110 may include, for example, compiler optimizations 114, counters 116, code cache 118, compiled classes 120 and compiled methods 122.

The source code 102 may be in one of a variety of human-readable programming languages. For example, the source code 102 may be a high-level language such as C++ or Java. Other programming languages are contemplated. To place the source code 102 in a machine-readable format, it is provided to a compiler 104 for compilation 104.

The compiler 104 translates the source code 102 from a high-level language into a lower level language such as an assembly language, Bytecode (in the case of Java), or machine code. Compilers perform many functions including preprocessing, lexical analysis, parsing, semantic analysis, and other operations. The compilation process includes a number of stages. For example, in the first stage the source code is checked for proper syntax. After that, the source code is translated into an intermediate representation. This intermediate representation allows for various optimizations of the application being created from the source code. Some optimizations may be specific to the code itself while other optimizations may be specific to the hardware architecture that will be executing the application. More detail about the optimizations will be discussed further below. As mentioned above, one type of compiler is a JIT compiler. The JIT compiler defers the compilation process until the application is running. In other words, compilation is performed at runtime.

After the compilation process is complete, or during the compilation process in the case of a JIT compiler, the application is in a format for execution on a machine. In one example, the executive instructions 108 are in the form of Bytecode. Bytecode is executable on a Java Virtual Machine (JVM). The JVM translates the bytecode into machine-readable code specific to whatever hardware will be executing the program. In some examples, the compiler will place the application directly into machine code for execution directly on hardware.

As mentioned above, the compilation process involves various compiler configurations that aid the compilation process for a specific application. According to principles described herein, a snapshot may be taken at some point after compilation has started. This may be either during compilation or after compilation has been completed. For example, with a JIT compiler, the snapshot may be taken during runtime (while the compilation process is occurring as well).

The snapshot may be stored in a predefined format. In some examples, the snapshot 106 is stored in memory (either volatile memory or non-volatile memory) of the computing system performing the compilation process. The snapshot 106 may be stored in various storage devices in connection to the computing system that performs the compilation process. In some examples, the snapshot 106 may be logged within the console.

The snapshot may include a variety of compiler configurations. In one example, the compiler configurations 112 include compiler optimizations 114. As mentioned above, there are different types of compiler optimizations. Some types of optimizations are specific to the code itself. For example, the compiler may look for extraneous code that does not affect the program operation and remove it. Or, the compiler may simply lines of code if several lines of code can be replaced with fewer lines of code. The compiler may also make adjustments and optimizations for specific processor architectures. For example, specific processors may have instruction sets that allow for certain types of complex operations to be performed with fewer processor instructions.

The snapshot 106 may include performance counters 116. In some cases, a compiler may use a performance counter to count how many times a particular section of code is called or executed. These counters can be helpful to determine which sections of the code are “hot” and could therefore benefit from recompilation or further optimizations.

The snapshot 106 may also include the contents of the code cache 118. For example, the JVM may use a code cache to store bytecode that has been compiled into native code. The code cache may be used heavily by JIT compilers.

The snapshot 106 may also include compiled versions of classes or methods. Object oriented programming languages such as Java define various functions such as classes or methods. Some classes or methods may be used more frequently by an application than others. Some classes or methods may thus be defined as “hot” classes or methods if they are used a more frequently than others by an objective measure. Such objective measures may be determined, for example, through use of performance counters as described above.

In one example, the application associated with the source code 102 may be a message broker application. A message broker application translates messages from one format to another. For example, a message broker may receive messages from a protocol or format specific to one application and format those messages into a protocol or format specific to a second application. The message broker may then send the newly formatted messages to the second application. Such an application may particularly benefit from the advantages of the techniques described herein. For example, the message broker may spend a substantial amount of time executing a particular section of code specific to changing data from one format to another. The performance counters will indicate such code as “hot” code and thus the compiler may make various optimizations to that code.

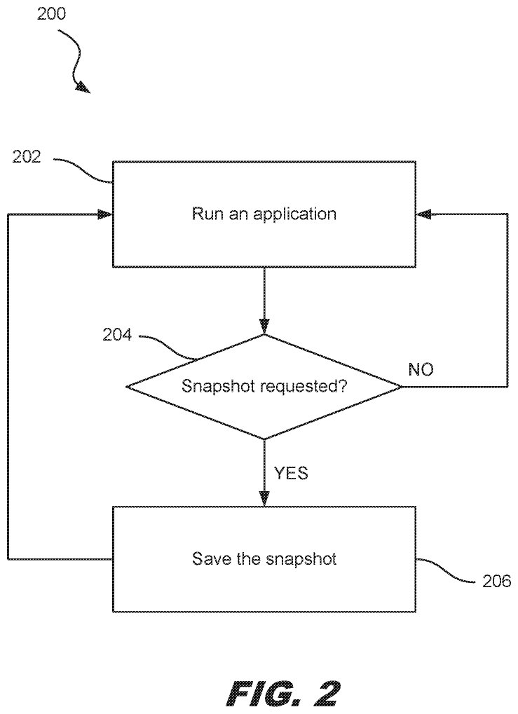

FIG. 2 is a flowchart showing an illustrative method for recording a snapshot. According to the present example, the method 200 includes a process 202 for running an application. In one example, the application is an Open Java Development Kit (OpenJDK) application. The application may be run from a command line, for example. In some examples, while running the application, a special flag may be set to inform the compiler or runtime environment that the recording and/or loading of snapshots is allowed. In some examples, the flag may indicate that only recording (not loading) of snapshots is allowed. In some examples, the flag may indicate that both recording and loading of snapshots is allowed.

The method 200 further includes a process 204 for determining whether a snapshot has been requested. The snapshot may be manually triggered by a user. For example, a software developer who may be testing an application, may determine that it would be useful to save a snapshot of the current compilation configurations. The user may request a snapshot in a variety of ways, including sending a command through a command line. If it is determined that a snapshot has not been requested (process 204, NO), then the method returns to process 202 at which the application continues to run as normal. If, however, the compiler determines that a snapshot has been requested (process 204, YES), then the method proceeds to the next process 206.

The method 200 further includes a process 206 for saving the snapshot (e.g., 106, FIG. 1). Saving the snapshot may involve saving various compiler configurations such as the performance counters, code cache, optimizations, and hot classes and methods. In some examples, the selection of which compiler configurations to include within snapshots may be specified by command line arguments. In other words, based on the command line arguments, the snapshot may include performance counters and optimizations, but not other options such as code cache. Thus, the snapshot may store only a subset of the available compiler configurations. The snapshot may be saved to a specific file path, which also may be defined in the command line. In some examples, the snapshot may be logged on the console. Then, after the snapshot has been loaded, the method 200 returns to step 202 at which the application continues execution as normal.

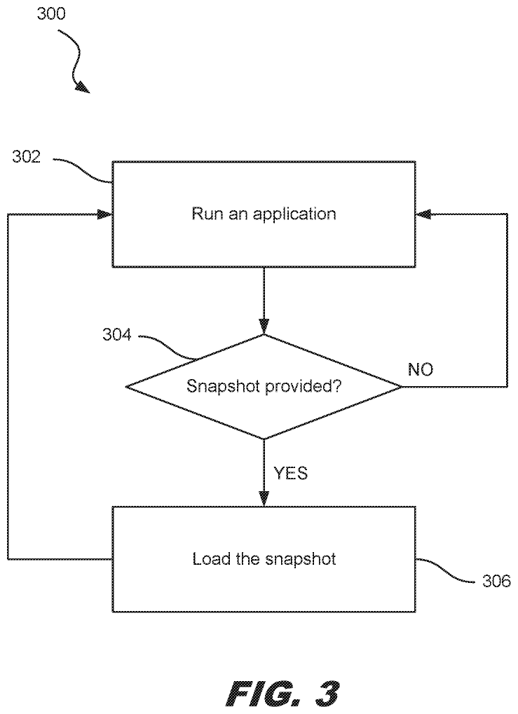

FIG. 3 is a flowchart showing an illustrative method 300 for loading a snapshot. According to the present example, the method 300 includes a process 302 for running an application. In one example, the application is an Open Java Development Kit (OpenJDK) application. This application may be the same application that was running when the snapshot was saved. Alternatively, the application may be a compatible version of the application from which the snapshot was recorded. The application may be run from a command line, for example. In some examples, while running the application, a special flag may be set to inform the compiler or runtime environment that the recording and/or loading of snapshots is allowed. In some examples, a flag may indicate that only loading (not recording) of snapshots is allowed. In some examples, the flag may indicate that both recording and loading of snapshots is allowed.

The method 300 further includes a process 304 for determining whether loading of a snapshot has been requested. The request to load a snapshot may be manually triggered by a user. For example, a software developer may be testing an application and determine that it would be useful to load a previously recorded snapshot. The user may request to load the snapshot in a variety of ways, including sending a command through a command line. If it is determined that loading a snapshot has not been requested (process 304, NO), then the method returns to process 302 at which the application continues to run as normal. If, however, the compiler determines that a snapshot has been requested (process 304, YES), then the method proceeds to the next process 306.

The method 300 further include a process 306 for loading the snapshot. To load the snapshot, the compiler may force a global safepoint. A safepoint is a point at which various threads are stopped or locked and it is safe to make various changes (such as loading a snapshot) without adversely affecting execution of the program. To load the snapshot, the various compiler configurations that were saved may be loaded to their respective location. For example, when loading a snapshot, the values in the performance counters may be replaced with the values of the performance counters from the snapshot. The code cache may be replaced with the contents from the code cache saved in the snapshot. The compiler optimizations may be loaded. The hot classes and methods may be loaded. Then, after the snapshot has been loaded, the method 300 returns to step 302 at which the application continues execution as normal.

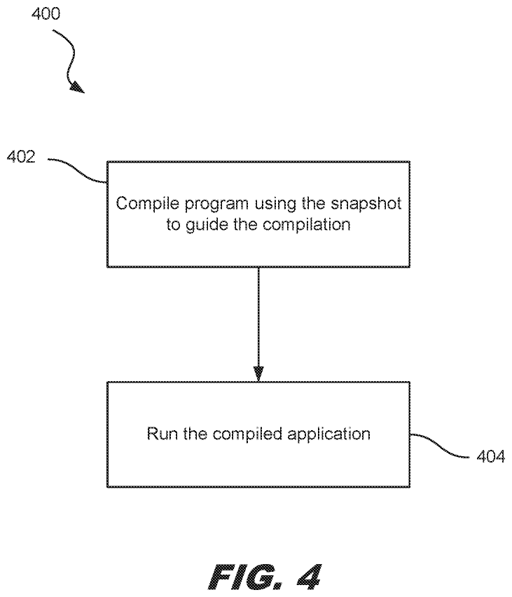

FIG. 4 is a flowchart showing an illustrative method for guiding ahead-of-time compilation. According to the present example, the method 400 includes a process 402 for compiling a program using a snapshot to guide the compilation process. For example, a snapshot of a program may be taken while that application is running in an environment associated with a JIT compiler. At a subsequent time, it may be desirable to perform an AOT compilation of the application. With the AOT application, the code for the application is compiled entirely before execution. However, there may be information in the snapshot that may be used to guide the AOT compilation process and thus reduce the amount of time it takes to compile the application. Reducing the amount of time it takes to compile the application improves the effectiveness and efficiency of the computing system performing the compiling. Additionally, using the optimizations from the snapshot, the final application may be smaller and thus take up less memory. The compiler optimizations from the snapshot may also be used to improve garbage collection processes. Garbage collection processes are used to automatically free up memory that is no longer needed by the application. Using the compiler optimizations from the snapshot, the AOT compiled application may have fewer virtual calls.

The method 400 further includes a process 404 for running the application that was compiled with the AOT compiler. Using the compiler optimizations obtained from the snapshot taken during JIT compilation, the AOT compiled application may be able to execute more efficiently than it otherwise would be (i.e., without using the snapshot to guide AOT compilation).

The techniques described herein may be used for GraalVM, which is a Java virtual machine based on HotSpot/Open JDK. The GraalVM includes a JIT compiler and an AOT compilation.

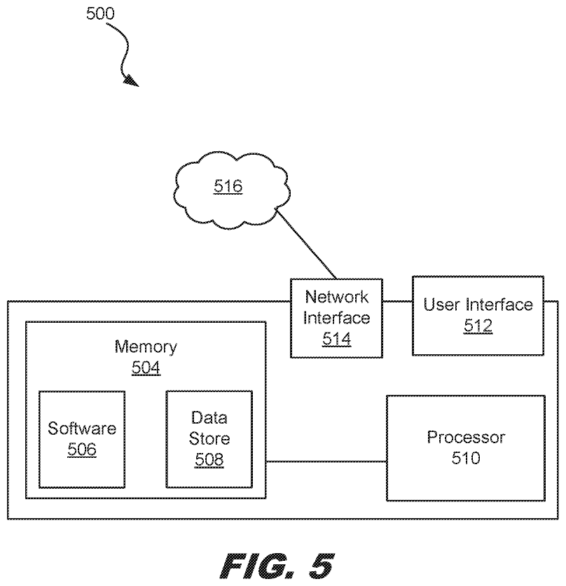

FIG. 5 is a diagram showing an illustrative computing system that may perform functions described herein, such as the functions described above in the text accompanying FIGS. 1-4. In other words, the computing system 500 may be used to perform the functions associated with the compiler 104. Other functions described herein may also be performed by computing systems such as computing system 500. According to certain illustrative examples, the computing system 500 includes a memory 504 which may include software 506 and a data store 508. The processing system 500 also includes a processor 510, a network interface 514, and a user interface 512.

The memory 504 may be one of several different types of memory. Some types of memory, such as solid-state drives, are designed for storage. These types of memory typically have large storage volume but relatively slow performance. Other types of memory, such as those used for Random Access Memory (RAM), are optimized for speed and are often referred to as “working memory.” The various types of memory may store information in the form of software 506 and data in the data store 508. The software 506 may include, for example, the application being compiled or the compiler itself. The data store 508 may store source code, compiled code, and the snapshots.

The computing system 500 also includes a processor 510 for executing the software 506 and using or updating the data 508 stored in memory 504. The software 506 may include an operating system and any other software applications a user may wish to install. In some examples, the computing system 500 may be associated with a user. The software 506 may include machine readable instructions of a computer program product that when executed, perform the functions described above in accordance with the text accompanying FIGS. 1-4.

The user interface 512 may include a number of input devices such as a mouse, touchpad, or touchscreen that allow the user to interact with the computing system 500. The user interface 512 may also include a number of different types of output devices such as a monitor or a touchscreen. The user interface allows the user to interact with the processing system 500 in a manner as described above.

The network interface 514 may include hardware and software that allows the processing system 500 to communicate with other processing systems over a network 516. The network interface 514 may be designed to communicate with the network 516 through hardwire media such as Ethernet, coaxial, fiber-optic, etc. The network interface 514 may also be designed to communicate with the network 516 using wireless technologies.

Some examples of processing systems described herein may include non-transitory, tangible, machine readable media that include executable code that when run by one or more processors may cause the one or more processors to perform the processes of methods as described above. Some common forms of machine readable media that may include the processes of methods are, for example, floppy disk, flexible disk, hard disk, magnetic tape, any other magnetic medium, CD-ROM, any other optical medium, RAM, PROM, EPROM, FLASH-EPROM, any other memory chip or cartridge, and/or any other medium from which a processor or computer is adapted to read.

Although illustrative examples have been shown and described, a wide range of modification, change and substitution is contemplated in the foregoing disclosure and in some instances, some features of the examples may be employed without a corresponding use of other features. One of ordinary skill in the art would recognize many variations, alternatives, and modifications. Thus, the scope of the invention should be limited only by the following claims, and it is appropriate that the claims be construed broadly and in a manner consistent with the scope of the examples disclosed herein.

1. A method performed by a computing system, the method comprising:
with a compiler, compiling source code to create an application for execution;
informing the compiler that a flag allows the recording and loading of a snapshot;
after the compiling has started, recording the snapshot of compilation configurations, the compilation configurations including information obtained by the compiler during the compiling;
storing the snapshot in a predefined format;
after storing the snapshot, loading the snapshot by configuring the compiler based on the compilation configuration in the snapshot.

2. (canceled)

3. The method of claim 1, wherein loading the snapshot comprises forcing a safepoint before configuring the compiler based on the compilation configuration in the snapshot.

4. The method of claim 1, wherein the compilation configurations include compiler counters.

5. The method of claim 1, wherein the compilation configurations include compiler optimizations.

6. The method of claim 1, wherein the compilation configurations include compiled classes and methods.

7. The method of claim 1, wherein the compilation configurations include code cache.

8. The method of claim 1, wherein loading the snapshot is triggered by a user.

9. The method of claim 1, further comprising, using the snapshot to perform an ahead-of-time compilation on the source code to create a file for execution on a physical machine.

10. The method of claim 1, wherein compiling the source code is performed with a just-in-time compiler.

11. The method of claim 1, wherein the application is a message broker application.

12. A system comprising:
a processor; and
a memory comprising machine-readable instructions that when executed by the processor cause the system to:
inform the compiler that a flag allows the recording and loading of a snapshot;
record the snapshot of accumulated compiler optimizations after compilation of an application by a compiler has started;
during a subsequent compilation of the application, load the snapshot by configuring the compiler with the accumulated compiler optimizations; and
continue compiling the application with the accumulated compiler optimizations.

13. The system of claim 12, wherein the recording the snapshot is triggered by a user.

14. The system of claim 12, wherein the loading the snapshot is triggered by a user.

15. The system of claim 12, wherein the snapshot is used to guide ahead-of-time compilation of the application.

16. (canceled)

17. The system of claim 12, wherein the snapshot further includes compiler counters and code cache.

18. A computer program product comprising non-transitory machine-readable media having machine-readable instructions for execution on a processor, the computer program product comprising:
code for, with a compiler, compiling source code to create an application for execution;
code for informing the compiler that a flag allows the recording and loading of a snapshot;
code for, after the compiling has started, recording the snapshot of compilation configurations, the compilation configurations including information obtained by the compiler during the compiling;
code for storing the snapshot in a predefined format;
code for, after storing the snapshot, loading the snapshot by configuring the compiler based on the compilation configuration in the snapshot.

19. The computer program product of claim 18, further comprising code for using the snapshot to perform an ahead-of-time compilation on the source code to create a file for execution on a physical machine.

20. The computer program product of claim 18, wherein the compilation configurations include at least one of: compiler counters, compiler optimizations, compiled classes and methods, and code cache.

21. The method of claim 4, wherein the compiler counters include a performance counter that counts how many times a particular section of code is called or executed.

22. The system of claim 17, wherein the compiler counters include a performance counter that counts how many times a particular section of code is called or executed.

23. The computer program product of claim 20, wherein the compiler counters include a performance counter that counts how many times a particular section of code is called or executed.
